(19) United States
(12) Patent Application Publication
(10) Pub. No.: US 2007/0207270 A1
(43) Pub. Date: Sep. 6, 2007

(54) Method of soak type coating and apparatus thereof

(75) Inventor: Tom Ku, Hsinchu (TW)

Correspondence Address: BRUCE H. TROXELL, SUITE 1404, 5205 LEESBURG PIKE, FALLS CHURCH, VA, 22041, US

(73) Assignee: Klaser Technology Inc.

(21) Appl. No.: 11/366,578

(22) Filed: Mar. 3, 2006

(51) Int. Cl. B05D 1/18; B05C 3/00

(52) U.S. Cl. 427/430.1; 118/429

(57) ABSTRACT

A method of soak type coating for a substrate being coated with coating liquid provides a pump to regulate velocity of gas being introduced into a container to control discharge velocity of the coating liquid in the first container so as to control velocity of the coating liquid separating from the substrate for obtaining better control of thickness of the coating layer on the substrate. Wherein, the gas introduced into the container is incapable of occurring chemical reaction with the coating liquid for obtaining preferable effect of coating.

### BACKGROUND OF THE INVENTION

1. Field of the Invention

The present invention is related to a method and apparatus for a substrate being coated with a coating layer and particularly to a method of soak type coating and an apparatus thereof.

2. Brief Description of Related Art

Generally, after a substrate being immersed in coating liquid, velocity of the substrate separating from the liquid level of coating liquid and stickiness of the coating liquid affect thickness of the coating film on the substrate. Slower separating velocity and more stickiness result in thicker coating film. Faster separating velocity and less stickiness result in thinner coating film.

Taiwanese Patent Publication No. 590807 discloses an immersion coating device for a thin slat shaped substrate and the device provides a hanging actuation mechanism to place the thin slat shaped substrate in the soak trough of a immersion coating mechanism and take out the substrate after finishing coating.

The preceding hanging actuation mechanism has to be precisely controlled moving speed without swinging or it is hard to control thickness of the coating film on the thin slat shaped substrate.

U.S. Pat. No. 6,214,419 discloses an immersion coating process provides a coating vessel with coating mixture inside. After the substrate having been immersed in the coating mixture, the liquid level of the coating mixture descends a short distance before velocity of the coating mixture being discharged gradually increasing to the largest velocity. Afterwards, the coating mixture is discharged from the coating vessel with the largest velocity.

The preceding coating mixture is discharged from the coating vessel by a pump. Because the pump delivers the liquid by means of pulses, the liquid is delivered with inconstant flow speed and it leads to inconsistent separating velocity of the coating mixture from the substrate such that the coating film on the substrate is formed unevenly.

### SUMMARY OF THE INVENTION

A main object of the present invention is to provide a method and an apparatus for soak type coating with which velocity of the liquid level of the coating liquid separating from the substrate is controlled steadily for the substrate obtaining preferable effect of coating.

Another object of the present invention is to provide a method and an apparatus for soak type coating with which specific gas is introduced into an air-tight coating container for the substrate obtaining preferable effect of coating.

### BRIEF DESCRIPTION OF THE DRAWINGS

The present invention can be more fully understood by reference to the following description and accompanying drawings, in which:

FIG. 1 is a perspective view of an apparatus of soak type coating according to the present invention;

### DETAILED DESCRIPTION OF THE INVENTION

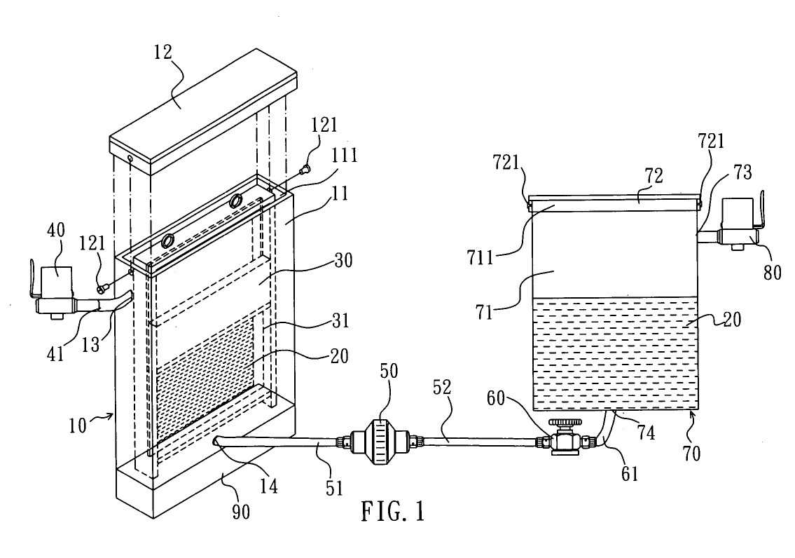

Referring to FIG. 1, an apparatus for soak type coating according to the present invention is employed to coat a substrate with coating liquid. A preferred embodiment of the apparatus for soak type coating according to the present invention includes a first container 10, which has a first receiving trough 11 for receiving the coating liquid 20 and the substrate 30; an opening 111 at the upper end of the first receiving trough 11; a cover 12, which is joined to the upper end of the first receiving trough 11 air-tightly to seal the opening 111. The first container 10 has a first inlet/outlet 13 and a second inlet/outlet 14 at the upper end and the lower end thereof respectively to communicate with the first receiving trough 11. The first inlet/outlet 13 communicates with a first pump 40 via a guide pipe 41 at another end thereof. The second inlet/outlet 14 communicates with an end of a throat valve 50 via a guide pipe 51 at another end thereof. Another end of the throat valve 50 communicates with an end of a valve 60 via a guide pipe 52. A second container 70, which has a second receiving trough 71 for receiving the liquid pigment 20; an opening 711 at the upper end of the second receiving trough 71; a cover 72, which is joined to the upper end of the second receiving trough 71 air-tightly to seal the opening 711. The second container 70 has a first inlet/outlet 73 and a second inlet/outlet 74 at the upper end and the lower end thereof respectively to communicate with the second receiving trough 71. The first inlet/outlet 73 communicates with a second pump 80 via a guide pipe 81 at another end thereof. The second inlet/outlet 74 communicates with another end of a valve 60 via a guide pipe 61 at another end thereof.

The second pump 80 introduces gas into the second receiving trough 71 of the second container 70 to create gas pressure exerting to the liquid level of the coating liquid 20 in the second container such that the coating liquid 20 in the second container 70 is able to pass through the guide pipe 74, the valve 60, the guide pipe 52, the throat valve 50 and the guide pipe 51 before being introduced to the first receiving trough 11. In this way, at least part of the substrate 30 is immersed in the coating liquid 20 of the first receiving trough 11.

The first pump 40 introduces gas into the first receiving trough 11 of the first container 10 to create gas pressure at liquid level of the coating liquid 20 in the first container 10 for the coating liquid 20 in the first receiving trough 11 discharges via the second inlet/outlet port 14 at the lower end of the first container 10. When the outlet for discharging the coating liquid 20 is fixed in size, discharge velocity of the coating liquid 20 can be controlled by means of controlling velocity of the pumped gas entering the first receiving trough 11. Thus, descending velocity of the liquid level of the coating liquid 20 in the first receiving trough 11 can be controlled such that separation velocity of the liquid level of the coating liquid 20 from the substrate 30 is controlled for controlling thickness of coating film on the substrate 30.

Because gas is more compressible than liquid, the gas in the first receiving trough 11 provides steady pressure to exert force to the liquid level of the coating liquid 20 even if the first pump 40 introduces the gas into the first receiving trough 11 by pulse. Hence, the coating liquid 20 in the first receiving trough 11 is capable of discharging with a constant velocity and the liquid level of the coating liquid 20 in the first receiving trough 11 descends uniformly to separate from the substrate 30 such that homogeneous thickness of the coating film on the substrate 30 can be obtained with more preferable effect of coating.

The throat valve 50 regulates the outlet port of the first receiving trough 11 to control the discharge rate of the coating liquid 20 in the first receiving trough 11.

When the coating liquid 20 in the first receiving trough 11 is discharged, the valve 60 is in a state of opening and the discharged coating liquid 20 is able to flow into the second receiving trough 71 of the second container 70. The second pump 80 is employed to withdraw gas in the second receiving trough 71 to increase the discharge velocity of the coating liquid 20 in the first receiving trough 11.

The apparatus of the present invention further includes a support stand 31 for the substrate 30 being placed there on and for the substrate 30 being in and out the first receiving trough 11 conveniently. Further, the lower end of the first container 10 is placed on top of a cushion pad 90 to dampen vibration from the first container 10 for facilitating coating process. It is preferable that the cushion pad 90 is a gas cushion pad.

The first cover 12 and the second cover 72 are provided with an elastic ring for closing the openings 111, 721 air-tightly. The first and second covers 12, 72 are joined to the upper ends of first receiving trough 11 and the upper ends of the second receiving trough 71 respectively with screw rods 121, 721.

While the coating liquid 20 in the second container 70 is guided into the first container 10, it is capable of allowing the first pump 40 withdrawing gas in the first container 10 at the same time and the second pump 80 introduces the gas into the second container 70 to speed up the coating liquid 20 in the second container 70 being introduced into the first container 10. The valve 60 is in a state of opening right at this time.

The gas, which is introduced into the first container 10 by the first pump 40, can be, for instance, air, nitrogen or any other idle gas depending on chemical property of the coating liquid 20 to avoid chemical reaction between the coating film on the substrate 30 and the gas molecules for obtaining better quality with desirable effect of coating.

Referring to FIG. 1 again, the preferred embodiment of a method of soak type coating according to the present invention includes the following steps:

(1) The substrate 30 is placed in the first container 10, which has the cover 12, and the coating liquid 20 is introduced into the first container 10 with at least part of the substrate 30 emerged in the coating liquid 20;

(2) The first pump 40 induces the gas into the first container 10 via the first inlet/outlet port 13 at the top of the first container 10 to create air pressure exerting the liquid level of the coating liquid 20 and to allow the the substrate 30 emerged in the coating liquid 20; coating liquid 20 discharging via the second inlet/outlet port 14 at the bottom of the first container 10 such that the liquid level of the coating liquid 20 in the first container 10 descends gradually to separate from the substrate 30 and the surface of the substrate 30, which touches the coating liquid 20, is covered with a coating layer;

Wherein, the first pump 40 is regulated to adjust velocity of the gas entering the first container 10 to control discharge velocity of the coating liquid 20 in the first container 10 so as to control separation velocity of coating liquid 20 in the first container 10 from the substrate 30 for controlling thickness of the coating layer on the substrate 30.

The method of the present invention further including a step of the throat valve 50, which communicates the second inlet/outlet port 14 of the first container, controlling discharge velocity of the coating liquid 20 in the first container 10 and the discharge liquid 20 entering the second container 70 after passing the valve 60 and the second inlet/outlet port 74 at the bottom of the second container 70. The second pump 80 sucks gas in the second container 70 out via the first inlet/outlet port 73 at the top of the second container 70 to increase the discharge velocity of the coating liquid in the first container 10. Other implements of the method according to the present invention have been described in the preceding apparatus of the invention.

It is appreciated that the invention allows descending velocity of the liquid level of the coating liquid being controlled steadily for enhancing quality of soak type coating and introduces gas unable to create chemical reaction with the coating liquid easily for the substrate obtaining better effect of coating.

While the invention has been described with referencing to a preferred embodiment thereof, it is to be understood that modifications or variations may be easily made without departing from the spirit of this invention, which is defined by the appended claims.

What is claimed is:

1. A method of soak type coating for a substrate being coated with coating liquid, comprising following steps:
(1) The substrate being placed in a first container, which has a cover, and the coating liquid being introduced into the first container with at least part of the substrate being immerged in the coating liquid; and
(2) a first pump inducing gas into the first container via a first inlet/outlet port at the top of the first container to create air pressure exerting liquid level of the coating liquid and for the coating liquid discharging via a second inlet/outlet port at the bottom of the first container such that the liquid level gradually separate from the substrate and the surface of the substrate, which touches the coating liquid, is covered with a coating layer;
wherein, the first pump is capable of regulating velocity of the gas entering the first container to control discharge velocity of the coating liquid in the first container so as to control velocity of the coating liquid in the first container separating from the substrate for controlling thickness of the coating layer on the substrate.

2. The method of soak type coating as defined in claim 1, wherein a throat valve is further provided in the step (2) to communicate the second inlet/outlet port for controlling velocity of the coating liquid discharging from the first container.

3. The method of soak type coating as defined in claim 2, wherein a valve is provided in the step (2) with an end thereof communicating with the throat valve and another end of the valve communicates with a second inlet/outlet port of a second container for the discharged coating liquid entering the second container.

4. The method of soak type coating as defined in claim 3, wherein a second pump is further provided in the step (2) to suck gas in the second container out via a first inlet/outlet port of the second container at the top of the second container to increase the discharge velocity of the coating liquid in the first container.

5. The method of soak type coating as defined in claim 1, wherein the gas introduced into the first container is incapable of creating chemical reaction with the coating liquid while processing the step (2).

6. The method of soak type coating as defined in claim 1, wherein the gas introduced into the first container in the step (2) is idle gas.

7. The method of soak type coating as defined in claim 1, wherein the step (1) further includes a second pump inducing gas into the second container via a first inlet/outlet port at the top of the second container to create gas pressure exerting liquid level of the coating liquid in the second container such that the coating liquid is discharged from a second inlet/outlet port at the lower end of the second container and entering the first container via a guide pipe, a valve, a throat valve and the second inlet/outlet port at the lower end of the first container.

8. The method of soak type coating as defined in claim 7, where in the step (1) further includes a first pump sucking gas in the first container via a first inlet/outlet port at the top of the first container to increase velocity of the coating liquid in the second container entering the first container.

9. A soak type coating apparatus for implementing the method of soak type coating defined in claim 1, comprising:
a first container, having a cover and a first receiving through with coating liquid and a substrate inside, providing a first inlet/outlet port and a second inlet/outlet port at the upper end and the lower end thereof respectively for communicating with the receiving trough; and
a first pump, communicating with another end of the first inlet/outlet port;
wherein, when operation of coating is processed, the cover is joined to the upper end of the first receiving trough air-tightly for closing an opening of the first receiving trough such that velocity of the coating liquid being discharged from the first container is controlled by means of the first pump regulating velocity of gas being introduced into the first container for controlling velocity of liquid level of the coating liquid separating from the substrate for controlling thickness of a coating film on the substrate .

10. The soak type coating apparatus as defined in claim 9, wherein a throat valve is provided to communicate with the second inlet/outlet port of the first container for controlling velocity of the coating liquid being discharged from the first container.

11. The soak type coating apparatus as defined in claim 10, wherein a valve is provided with an end thereof communicating with the throat valve and another end of the valve communicates with a second inlet/outlet port at the lower end of a second container for the discharged coating liquid entering the second container.

12. The soak type coating apparatus as defined in claim 11, wherein a second pump is further provided to communicate with a first inlet/outlet port at the upper end of the second container for sucking out gas in the second container so as to increase velocity of the coating liquid being discharged from the first container or a second pump inducing gas into the second container via an inlet/outlet port at the upper end of the second container to create gas pressure exerting liquid level of the coating liquid in the second container such that the coating liquid is discharged from a second inlet/outlet port at the lower end of the second container and entering the first container via a guide pipe, the valve, the throat valve and the second inlet/outlet port at the lower end of the first container.

13. The soak type coating apparatus as defined in claim 9, wherein the gas, which is introduced into the first container, is incapable of occurring chemical reaction with the coating liquid.

14. The soak type coating apparatus as defined in claim 9, wherein the gas introduced into the first container is idle gas.

15. The soak type coating apparatus as defined in claim 9, further comprises a support stand for being attached with the substrate and for the substrate being received in or taken out from the first receiving trough.

16. The soak type coating apparatus as defined in claim 9, further comprises a cushion pad and the lower end of the fist container is placed on the cushion.

17. The soak type coating apparatus as defined in claim 16, wherein the cushion pad is a gas cushion pad.
